(19) United States
(12) Patent Application Publication
(10) Pub. No.: US 2025/0315994 A1
(43) Pub. Date: Oct. 9, 2025

(54) Adaptive Refiner based Few-Shot Font Generation

(71) Applicant: Monotype Imaging Inc., Woburn, MA (US)

(72) Inventors: Venkateswarlu Yetrintala, Palatine, IL (US); Avinash Thakur, Ghaziabad (IN); Mohit Gupta, Delhi (IN); Neeraj Gulati, Gurgaon (IN); Vipul Arora, Jalandhar (IN)

(21) Appl. No.: 19/085,947

(22) Filed: Mar. 20, 2025

Related U.S. Application Data
(60) Provisional application No. 63/567,868, filed on Mar. 20, 2024.

(51) Int. Cl. G06T 11/20; G06V 30/18

(52) U.S. Cl. CPC G06T 11/203; G06V 30/18133

(57) ABSTRACT

Methods, system, and apparatus, including computer programs encoded on a computer storage medium. for generating fonts. In one aspect. a method comprises generating glyphs for one or more fonts using an adaptive refiner model.

### CROSS-REFERENCE TO RELATED APPLICATION

This application claims the benefit of U.S. Provisional Application No. 63/567,868, filed on Mar. 20, 2024, the contents of which are incorporated by reference herein.

### BACKGROUND

This description relates to fonts and rendering the fonts to present textual content. Along with the growth of available textual content from many sources that are Internet accessible, the number of available fonts to present the textual content has grown by a staggering amount.

Proportional to the astronomical growth of available textual content, for example via the Internet, user demand to express such content has grown. Similar to the variety of products provided by online stores; content authors, publishers, graphic designers, etc. have grown accustomed to having a vast variety of fonts to present textual content.

### SUMMARY

This specification relates to using few-shot font generation (FFG) techniques.

In one aspect, a computing device implemented method includes generating glyphs for one or more fonts using an adaptive refiner model. In another aspect, a system includes one or more computer and one or more storage devices storing instructions that are operable, when executed by the one or more computers, to cause the one or more computers to perform operations comprising generating glyphs for one or more fonts using an adaptive refiner model. In another aspect a computer storage medium encoded with a computer program, the program comprising instructions that are operable, when executed by a data processing apparatus, to cause the data processing apparatus to perform operations comprising generating glyphs for one or more fonts using an adaptive refiner model.

In one general aspect, a method is performed by a server. The method includes: obtaining, as output from a machine learning model, second image data of a set of character glyphs associated with a font, wherein the second image data was generated from first image data; determining the second image data comprises one or more style inaccuracies; in response to determining the second image data comprises the one or more style inaccuracies, providing, as input to an adaptive refiner model, the first image data and the obtained second image data; obtaining, from the adaptive refiner model, third image data comprising modifications to the one or more style inaccuracies found in the second image data.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, obtaining, as output from the machine learning model, the second image data of the set of character glyphs with the font includes: receiving data representing a character glyph associated with the font; generating first image data from the character glyph; and providing, as input to the machine learning model, the generated first image data.

In some implementations, providing, as input to the machine learning model, the generated first image data includes providing, as input to a stable diffusion model, the generated image data.

In some implementations, the method further includes determining the second image data comprises the one or more inaccuracies includes determining the second data comprises determining one or more inaccuracies comprising a slant, a thickness, a length, and local style features of the font.

In some implementations, the method includes determining the second image data comprises the one or more inaccuracies comprises determining the second data comprises determining one or more inaccuracies comprising a slant, a thickness, a length, and local style features of the font.

In some implementations, providing, as input to the adaptive refiner model, the generated first image data and the obtained second image data includes: generating input data that includes a concatenation of the generated first image data and the obtained second image data; and providing, as input to the adaptive refiner model, the generated input data that comprises the concatenation.

In some implementations, the first image data, the second image data, and the third image data include rasterized images.

In some implementations, the method further includes: generating a vector format of the obtained third image data of the set of character glyphs; scaling the generated vector format to match to a form of the data representing the character glyph; and providing the scaled vector of the set of character glyphs for output, wherein the scaled vector comprises a set of character glyphs associated with the font.

The subject matter described in this specification can be implemented in various embodiments and may result in one or more of the following advantages.

The system can use an adaptive refiner to modify the glyph output of a base generator to produce more accurate and visually appealing glyphs for various fonts.

Instead of finetuning the base generator to generate more precise glyph outputs based on desired aesthetic and style criteria, the system can determine that the glyph output of a base generator should be refined using the adaptive refiner and refine the glyph output to generate a glyph with the desired aesthetic and style criteria. Generally, the base generator is a complex machine learning model, e.g., a stable diffusion model, that has a large number of parameter values. In contrast, the adaptive refiner can be implemented as a lightweight machine learning model, e.g., with a less complex architecture, less parameter values, or both with respect to the base generator. Therefore, deferring style modifications to the lightweight adaptive refiner model can reduce the use of computational resources needed to generate font glyphs with the desired aesthetic and style criteria, e.g., relative to training or finetuning the base generator.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system for generating new fonts using few-shot learning with an adaptive refiner.

FIG. 2 is a block diagram that illustrates an example of a system that utilizes artificial intelligence techniques to generate new fonts based on input characters.

FIG. 3 illustrates ground truth font characters and generated font characters.

FIG. 4 graphically represents a refiner output of one font as a base generator.

FIG. 5 is a block diagram that illustrates an example of a flow chart that illustrates a creation of a new font from a target font.

FIG. 6 is a flow diagram that illustrates an example of a process for utilizing an adaptive refiner to produce a refined image of a glyph.

FIG. 7 illustrates an example of a computing device and a mobile computing device that can be used to implement the techniques described here.

Like reference numbers and designations in the various drawings indicate like elements.

### DETAILED DESCRIPTION

In some implementations, the techniques described in this specification include the use of an adaptive refiner to refine the output of a base generator. The adaptive refiner utilizes few-shot font generation (FFG) to generate glyphs as a function of an input character and a target character.

A base generator receives as input a set of rasterized glyphs in the target style and the target character. However, when a base generator generates glyphs, the base generator can produce inaccurate and incongruent glyphs that require refinement to match a target style. As described throughout this specification, an adaptive refiner model can produce a refined image of a glyph from one or more style inaccuracies in the glyph produced by the base generator.

In some cases, the base generator model is a finetuned AI model that can output an image of a generated glyph. For example, the system can provide the image data to the adaptive refiner for refining the images. The system can then reinsert the refined output image into the vectorization process, as further described below.

In some cases, the output of the adaptive refiner model can contain a rasterized image that contains the local style details which were missing from the glyphs generated from the base generator. More specifically, the adaptive refiner is configured to output glyphs as rasterized images that possess desired style characteristics that are missing from the output of the base generator, like sharpness, continuity, and symmetry, to name a few examples. The adaptive refiner refines the glyphs based on the content of the glyphs themselves.

In particular, the adaptive refiner can learn to adapt the output to the target style through a finetuning process. For example, the adaptive refiner can be finetuned to learn features that include a slant, a thickness, a length, and local style features of a particular font. In some implementations, the input to a refiner can include a concatenated version of the input rasterized image provided to the base generator, e.g., finetuned AI model, and the rasterized image output by the base generator. The adaptive refiner is finetuned using at least three loss types during adaptation: (1) adversarial loss to generate realistic glyphs, (2) perceptual loss to generate glyphs that are perceptually similar to the ground truth, and (3) L1 loss to generate glyphs that match the ground truth at pixel-level.

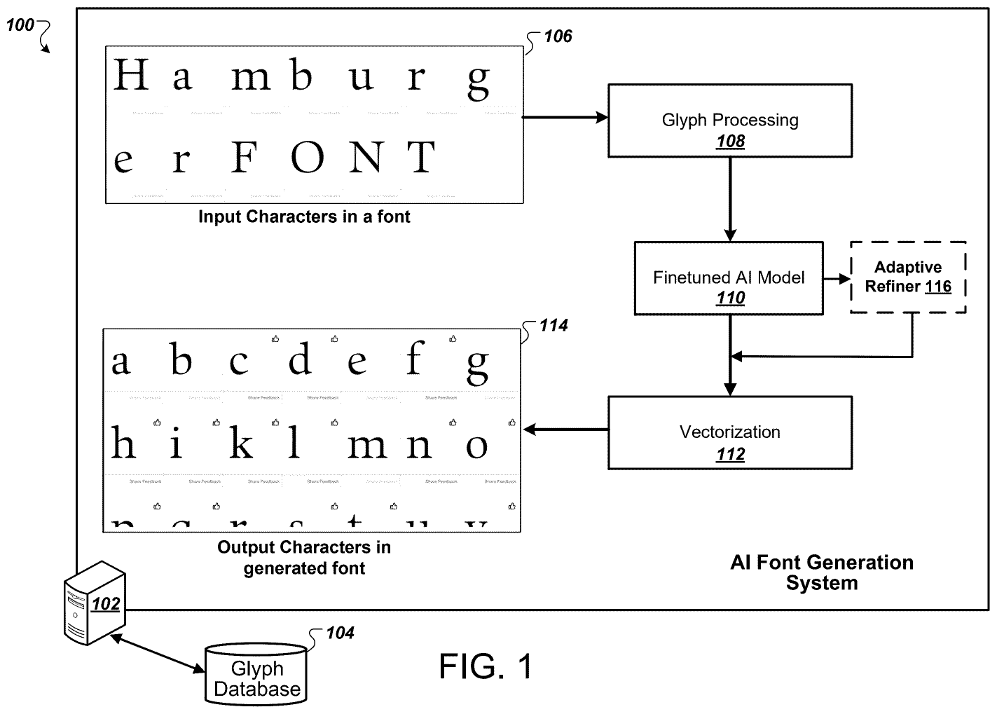

FIG. 1 is a block diagram that illustrates an example of a system 100 for generating new fonts using few-shot learning. In some implementations, the system 100 comprises an artificial intelligence (AI) font generation system 102 and a glyph database 104. The AI font generation system 102 and the glyph database 104 can communicate over a network, such as the Internet. One or more user devices, e.g., client devices, can connect to and interact with the components of the AI font generation system 102.

Typography can play an essential role in modern communication, branding, and design. Traditional font creation is a time-consuming process that can require expert knowledge and meticulous attention to detail. This can often take weeks, months, or longer for a designer to develop a fully realized typeface. Over the years, digital tools have simplified some aspects of typography—designers can more easily manipulate outlines, modify spacing, and iterate on shapes than ever before. Yet, creating novel fonts that maintain visual consistency and character cohesion across an entire typeface remains a significant challenge.

In some cases, the system 100 can automatically generate fonts by using machine learning models that have been trained on large datasets of existing typefaces. For instance, generative adversarial networks (GANs) and other deep learning techniques have demonstrated their ability to produce glyphs resembling those found in high-quality, professionally designed fonts. However, these methods may rely on extensive training data, which can be difficult and costly to assemble. Moreover, they may generate results that lack the unique aesthetic flair envisioned by a human designer.

The industry is increasingly interested in “few-shot learning” techniques that can produce new and coherent typefaces from only a small sample of characters. By supplying a limited set of glyphs—such as a handful of letters—designers can guide the system to extrapolate stylistic features and apply them consistently across the entire alphabet. This approach not only precludes the need for extensive up-front design but also makes the process more efficient and collaborative, allowing the designer's creativity to guide the machine learning model.

The system 100 leverages few-shot learning to combine the strengths of human-led design with the efficiency of automated generation. By requiring only a small set of glyphs as input from a designer, the proposed system can quickly create a full range of glyphs while preserving the designer's intended aesthetic. Accordingly, the system 100 aims to fill a growing industry need for rapid, scalable, and customized font creation pipelines.

In some implementations, the system 100 can enable rapid and customized font creation by leveraging one or more few-shot learning mechanisms. For example, the system 100 can start with a designer providing a small set of hand-drawn characters, reflecting their desired font aesthetic. Using a form of the small set of hand-drawn characters, a fine-tuning artificial intelligence model can extrapolate from these initial characters to generate additional glyph images in a similar style, e.g., to generate remaining glyphs of the font in the desired user style. In response, the system 100 can transform the AI-generated additional glyph images into vector outlines, for example. The vector outlines can align seamlessly with the designer's original look and feel-including consistent scale and alignment.

In some cases, a designer can supply any number of initial characters. In some cases, the system 100 can retrieve any number of initial characters from the glyph database 104. In this manner, the system 100 allows for both a minimum number of inputs and a more comprehensive direction based on specific project needs.

In some implementations, the AI font generation system 102 can create a font by leveraging one or more few shot learning mechanisms. These mechanisms can include, for example, functions associated with glyph processing 108, functions associated with a finetuned AI model 110, an adaptive refiner 116, and functions associated with vectorization 112. As mentioned, the AI font generation system 102 can receive one or more input characters of a particular font type, and use these mechanisms to generate output characters in the desired font from the input type.

In some examples, the input characters 106 in a particular font may include the glyphs for “hamburgerFONT” or another font as an example of a font that is similar to the user's desired aesthetic. The input characters 106 here include a set of number of lower-case letters and a set number of upper-case letters. In some examples, the one or more input characters 106 can be retrieved from the glyph database 104. In some examples, the input characters 106 can be received from a user through a client device or a user directly interacting with the AI font generation system 102.

In some implementations, the glyph database 104 can store the glyphs and characterization data for a set of character glyphs in the font. The characterization data can include stroke attributes. The stroke attributes can represent a numerical control method to render each stroke of the character glyph. The AI font generation system 102 can utilize the characterization data to inform available font options for font generation. The AI font generation system 102 can retrieve the glyphs from the font genome stored in the glyph database 104 for producing an output character set representative of a font.

Generally, the AI font generation system 102 can process the input character or characters 106 using the finetuned AI model 110. The finetuned AI model 110 can produce a total set of output characters 114 in the particular font, e.g., such as lowercase letters “a” through “z” and upper-case letters “A” through “Z”. The finetuned AI model 110 can analyze various characteristics of the input characters 106, e.g., the style, the kerning, the right/left side bearing around the strokes of each character, and other characteristics, to gain an understanding of the desired font to be applied to output characters 114. In some implementations, the AI font generation system 102 can produce output characters 114 in the generated font. The output characters 114 can include each character of the alphabet in lower case and upper-case, numbers 0 through 9, and various symbols, to name a few examples. The AI font generation system 102 can present the output characters 114 in the generated font through a glyph application, e.g., one or more user interfaces for font generation and selection, presented to a user on a display of a connected user device.

In some implementations, the finetuned AI model 110 can output a representation of the output characters. The representation may include, for example, raster images for each output character or other data types of representative of the output characters.

In some implementations, the AI font generation system 102 may provide the representation of the output characters to the adaptive refiner 116 if the AI font generation system 102 detects one or more issues with the output characters. The one or more issues can include, for example, stylistic inaccuracies with a slant of a glyph, a thickness of the glyph, and a length of the glyph. The adaptive refiner 116 can refine or modify the output characters to correct the one or more issues. The AI font generation system 102 can then provide the modified output characters to the vectorization 112.

Before the output characters are presented to the user, e.g., for selection, the AI font generation system 102 can provide the representation of the output characters through one or more functions associated with vectorization 112. As an example, the vectorization 112 can refit the represented output characters back to a format to be presented in a glyph application. As will be further described below, the vectorization 112 can include reformatting the output characters with proper spacing between characters, proper orientation, correct scaling, and similar format, to name a few examples.

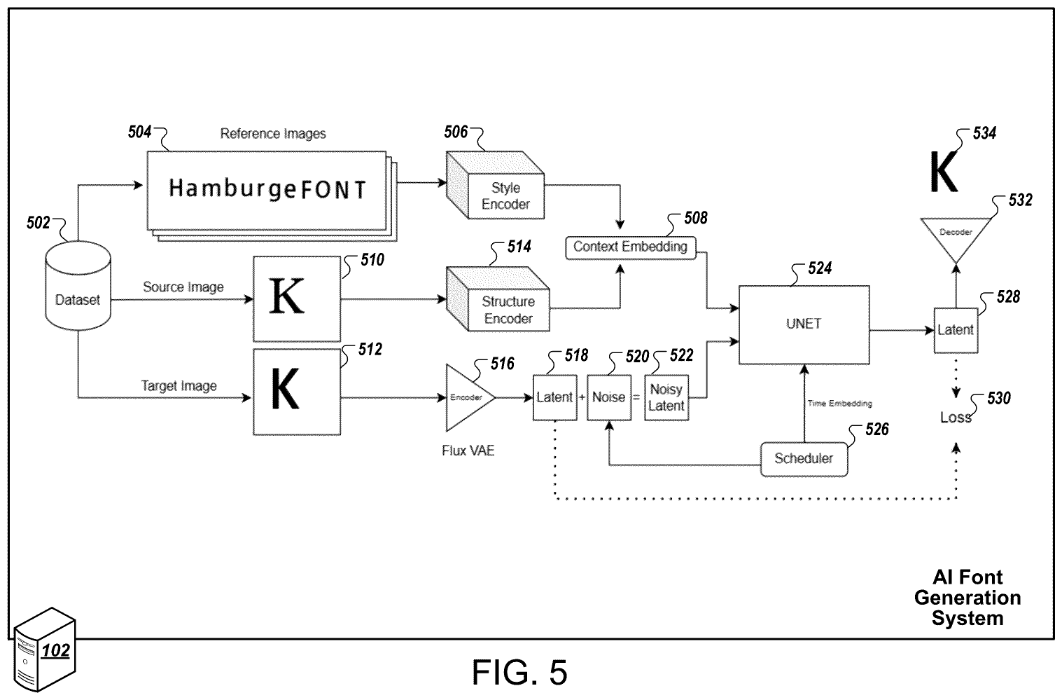

In some cases, the AI font generation system 102 can receive feedback on each of the generated output characters 114. The feedback can include an indication of whether the character data is properly produced by the finetuned AI model 110. In this context, the system can verify that the aesthetic consistency of the fonts and verify whether any spurious artifacts were generated, e.g., a line that is too long on an “q” glyph. The user can indicate that a particular character is acceptable or needs fixing, e.g., through a graphical user interface (GUI) presented through the display of the user device. If the AI font generation system 102 receives feedback for a particular character that needs fixing from a user, then the AI font generation system 102 can attempt to reprocess that particular character, such as using the process shown in FIG. 5 below.

In some implementations, the output characters 114 in the generated font may be stored in the glyph database 104. In some cases, the output characters 114 may be further redefined using one or more other machine learning models. In some cases, these output characters 114 may be applied to one or more applications for use and deployment.

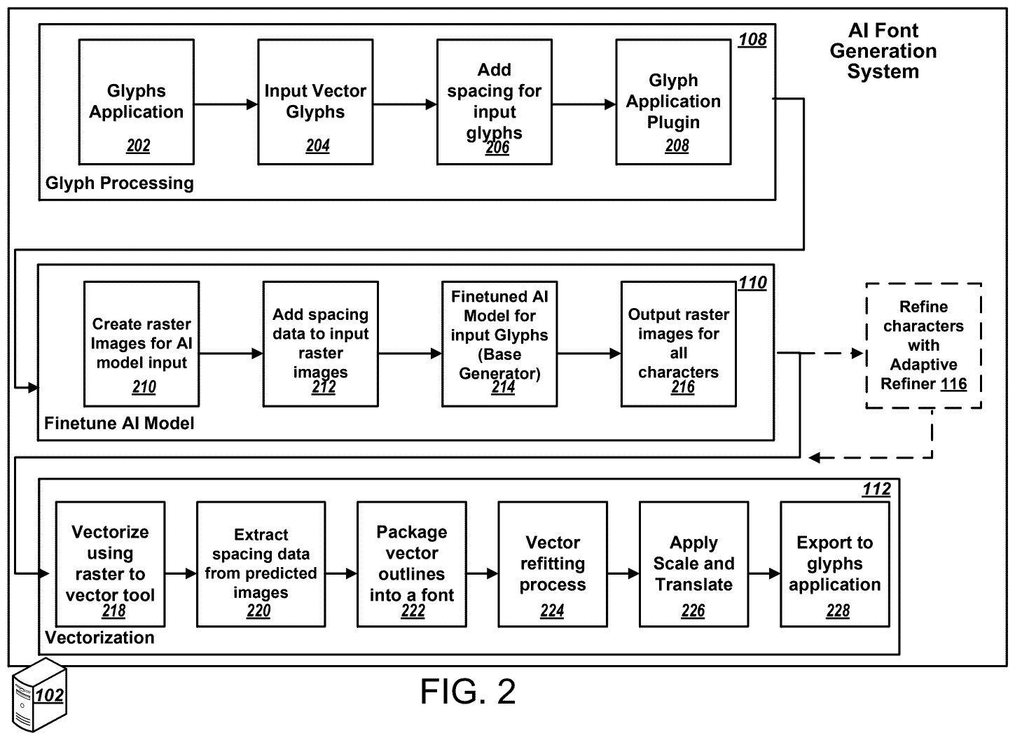

FIG. 2 is a block diagram that illustrates an example of a system that utilizes artificial intelligence techniques to generate new fonts based on one or more input characters. The system shown in FIG. 2 illustrates the processes performed by the AI font generation system 102. These processes include, for example, glyph processing 108, processing the set of input characters 106, a finetuned AI model 110 processing output of the glyph processing 108, and vectorization 112 which processes the output of the finetuned AI model 110. The vectorization 112 results in providing the output glyphs to a glyph application for presentation to a user, e.g., on a display of a user device.

In some implementations, each of the glyph processing 108, the finetuned AI model 110, and the vectorization 112 can include one or more functions. The functions for the glyph processing 108 can include, for example, a glyphs application 202, an input vector glyphs 204, a function to add spacing for input glyphs 206, and a glyph application plugin 208. For example, the glyph application plugin 208 is software tool that adds additional functionality to the glyph application. The functions for vectorization can include, for example, a vectorize using raster to vector function 218, extract spacing data from predicted images function 220, package vector outlines into a font function 222, vector refitting function 224, apply scale and translate function 226, and export to glyphs application function 228.

At 202, the AI font generation system 102 presents a glyphs application. A glyph, which is a specific shape, design, or representation of a character, can be input or created using a glyphs application. In particular, the glyphs application can be a software application that allows users to draw, edit, and test characters, manage font production, and extend various functionality of font creation to plugins and other scripts. The glyphs application can also retrieve glyphs from the glyph database 404 for producing and creating other fonts.

In some cases, the glyphs application can be presented on a user device, e.g., a tablet, a personal computer, or a mobile device. The glyphs application can be accessed through a browser over the Internet or downloaded from the Internet to the user device. A user can interact with the glyphs application through a touchscreen, a mouse and keyboard setup, a stylus, or another type of input.

At 204, a user can input one or more glyphs, and the AI font generation system 102 can interpret and process the one or more glyphs as vectors. The one or more glyphs can be included as vector representations. The vector representations can include one or more points, one or more vectors of the glyphs, and other representations that connect to together to form the glyph. These vectors or attributes can be sized and scaled according to their scalar data, vector magnitude, and their corresponding direction.

At 206, the user can provide spacing data for the input glyphs through the glyphs application. In particular, the user can input spacing data into the glyphs application that includes left-side bearing and right-side bearing. The left-side bearing includes one or more points of spaces to the left of a glyph. Similarly, the right-side bearing includes one or more points of spaces to the right of a glyph.

In this manner, the left-side bearing, and the right-side bearing prevent the glyph being processed from overlapping with other glyphs. Moreover, the addition of spacing data makes the glyphs more visually appealing to the user. Similarly, the left-side bearing and the ride-side bearing ensure that the other glyphs do not overlap with the glyph being processed. For example, without spacing, the tail on a capital letter “Q” may overlap with another letter “u” in the word “Quit.”

In some cases, the user can also provide spacing data above the glyphs, e.g., numbers, letters, etc., and below the glyphs. This spacing may distinguish characteristics of a letter, such as providing a space between the tittle and the letter below it in the “i.” As another example, some stylistic fonts can include glyphs that frequently overlap, which can be corrected by the user. In this manner, a user can add spacing to each letter to prevent overlap in subsequent letters in a particular word. The spacing data may be stored in the glyph database 404 with the font genome.

At 208, the glyphs application can provide a plugin that can be used by the developer. In some implementations, a plugin is software that can extend the application's functionality, provide new tools not typically offered by the application, features, or other functionalities to enhance the font design workflow. For example, the plugins can include a filter plugin, a palette plugin, and one or more tool plugins.

As illustrated in FIG. 2, the plugin can include functions that relate to converting the vectors that constitute the glyph into one or more different representations to provide as input to a finetuned AI model. As will be further described below, the finetuned AI model 110 can process the vector as the one or more different representations and output a set of characters to provide to the glyphs app in a designated font.

At 210, the plugin function of the glyph application can generate a raster image of the vector representation of the glyphs. A raster image is a digital image that is composed of a grid of tiny, colored squares, such as pixels. Each pixel in the raster image can contain color and brightness information. In some cases, the raster image is a black and white image. The quality of the raster image can vary depending on the number of pixels in each image.

The input to the finetuned AI model operates on raster images. Accordingly, each of the input glyphs provided in 202 and adjusted for spacing in 206 is rasterized. The finetuned AI model generates a raster image for each of the input glyphs. However, to ensure that the finetuned AI model can process each of the input glyphs as raster images, the AI font generation system 102 ensures that there is ample spacing in the raster images to distinguish these characters and to avoid any overlap.

At 212, the AI font generation system 102 adds spacing data to each of the input raster images. The spacing data in 212 is required for the input raster images in addition to the spacing data provided in 206. Here, the AI font generation system 102 adds spacing data to each of the input raster images to ensure the output from the finetuned AI model also includes spacing data for the output characters.

The spacing data can be added automatically, such as through the use of one or more lines to the left and right of each the characters in the raster image data, or added as extra points to the left and right of each the characters in the raster image data. In some cases, the AI font generation system 102 can add spacing data as metadata to each of the raster images. The metadata can include the pixels where spaces or lines are to be included in the raster images. In this manner, the finetuned AI model can process the raster image and/or the metadata of the raster image to correctly produce output characters with the spacing data.

Moreover, by including spacing data in the raster images, the finetuned AI model will improve its prediction capabilities. For example, the finetuned AI model can learn, through the analysis of a raster image for a particular letter, how to create a raster image of another letter, such as producing the letter “V” from the letter “A.” In this manner, the finetuned AI model can generate a set of character of an alphabet in a particular font from a single character alone.

At 214, the AI font generation system 102 can provide the raster images as input to the finetuned AI model. The AI font generation system 102 can process the rasterized images, analyze their features, and generate or predict output raster images for all characters. The input rasterized images can be of any size as specified by the glyphs application in 202.

The finetuned AI model 110 can have any appropriate machine learning architecture, e.g., a neural network, which can be configured to process an input of one or more font glyphs to generate at least the remaining glyphs of the font. In particular, the finetuned AI model 110 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In particular, the finetuned AI model 110 can be implemented as any appropriate generative neural network. For example, the finetuned AI model 110 can be or can include a stable diffusion machine learning model that has been configured to generate a high-quality image by updating a noisy image to match the intended image according to the data included in the rasterized image. More specifically, the stable diffusion machine learning model can be configured to sequentially refine an initial state representing the rasterized image through a sequence of transformations that add noise to a data sample to generate the output rasterized image.

At 216, the finetuned AI model 110 can generate an output of a raster image for all glyphs in the font using the input raster images. For instance, the finetuned AI model can output all characters in a particular font from the input, including lowercase letters “a” through “z” and upper-case letters “A” through “Z.” In some cases, the finetuned AI model can generate characters in one or more alphabets, e.g., for English, French, Greek, Russian, etc. languages. In some cases, the characters can also include numbers and symbols in the particular font from the input raster images. The AI font generation system 102 can store these output raster images in a database for future training, for example. In some examples, the output of the rasterized image can be of size 512 pixels by 512 pixels.

In some implementations, the AI font generation system 102 may determine that one or more inaccuracies exist with the output raster image for all the glyphs. For example, the system 102 can evaluate whether the output raster image satisfies one or more criteria. In some cases, a user of the system can configure the one or more criteria, e.g., in accordance with desired aesthetic characteristics. The one or more criteria can include a structure of a glyph, a style of a glyph, a desired aesthetic, or other types of criteria. In other cases, the system can evaluate the output raster image using a set of default style criteria.

In the case that one or more of the glyphs do not satisfy the criteria, the AI font generation system 102 can provide the output raster image for the glyphs that do not satisfy the criteria as the corresponding input raster images from 212 to the adaptive refiner model to refine the glyphs 116. In particular, the adaptive refiner can refine or correct the slant, the thickness, and the local style features of a particular font. The adaptive refiner can refine the inaccurate glyphs according to the characteristics associated with the particular font. For example, the adaptive refiner can seek to refine the glyphs for uniformity according to the particular font. In the case that the system 102 refines the glyphs 116, the output of the adaptive refiner model serves as the input to the vectorization process at 218.

In few-shot generation (FFG), the adaptive refiner model 116 is trained to generate glyphs as a function of character ‘c’ and the target style ‘s’. The rasterized image of the glyph is denoted as X(c, s) in a target font ‘t’ using a few reference glyphs. A base generator F(θ), with parameters θ, takes as input a set of rasterized glyphs {X(ctk, st)}Kk=1 in the target style st and the target character ct. The target character ct could be supplied as either a one-hot vector or a rasterized glyph X(ct, s0) in some base font s0 for which glyphs for all characters are available. The base generator or the finetuned AI model generates \hat{ }X1(ct, st). Any FFG model can be used as the base generator.

Many times it is observed that the FFG models generate glyphs that lack local style details. In other words, while these models are exceptionally good at learning the global shape of glyphs, there are local incongruencies that need further refinement. The system of this specification includes a refiner model Go which processes \hat{ }X1(ct, st) locally, i.c., using fully convolutional architecture, to produce a refined rasterized glyph \hat{ }X2(ct, st). The refined glyph \hat{ }X2(ct, st) contains the local style details which were missing or incorrectly generated in \hat{ }X1(ct, st) and is thus closer to the target style. In case of unseen styles, it is difficult to expect the FFG models to generalize well. This is because these models use the information about st as input, but not to finetune their weights. The system can use domain adaptation methods to adapt the model to the target style st using a {X(ctk, st)}Kk=1. Since F(θ) has a large number of parameters, the system can adapt the relatively lightweight adaptive refiner model Gφ 116, thereby reducing the use of computational resources, e.g., computational memory and processing power, needed to generate an output glyph in the desired style relative to finetuning the base generator.

The adaptive refiner model Go 116 can be finetuned in a few training steps to adapt to the target font st using {X(ctk, st)}Kk=1. The adaptive refiner model 116 can learn global style features like slant and thickness and local style features like serif in the target font and add them to \hat{ }X1(ct, st) suitably. The adaptive refiner model 116 takes as input \hat{ }X1(ct, st) and X(ct, s0) in the base font to refine the glyphs based on the content of the glyph. The input to the adaptive refiner model 116 is therefore:

$$X 1 ( ct , st ) in = concat ( {}^{⋀} X 1 ( ct , st ) , X ( ct , s 0 ) ) \qquad ( 1 )$$

Spatial transformer networks (STN) can be used to learn affine transformations which when applied to feature maps can learn global transformations like scaling, rotation, and translation. For example, STN layers in the refiner can learn global style features like slant and thickness effectively. Deformable convolutional layers (DCN) are superior to convolutional layers due to their ability to increase their receptive field using learnable offsets. They can learn more complex features with minimal additional parameters which makes them more effective for image translation and generation tasks. The refiner can be viewed as performing image translation between \hat{ }X1(ct, st) and \hat{ }X2(ct, st) where it adds the target font features that were missing or incorrectly generated by the baseline generator. As an example, DCN layers can learn these complex style features during adaptation and then apply it to other glyphs during inference.

The adaptive refiner model 116 includes residual blocks and convolutional blocks to increase the model depth which helps it to learn intricate style features. The skip connections in the residual block allow a stable backpropagation within refiner layers avoiding the vanishing gradient problems. Thus, the refiner operation can be written as

$$X 2 ( ct , st ) = G φ {(}^{⋀} X 1 ( ct , st ) ) \qquad ( 2 )$$

During adaptation, the adaptive refiner model 116 is trained adversarially to output glyphs that possess characteristics like sharpness, continuity, and symmetry. For example, the adaptive refiner model 116 can be implemented using the multi-class binary discriminator architecture and initialize it with pretrained weights. Since the adaptive refiner model 116 can be updated to learn one font at a time during adaptation, the last layer can be replaced with a single neuron. Only the last two layers of the discriminator are re-trained during adaptation of the adaptive refiner model 116. The discriminator classifies whether a glyph was generated by the adaptive refiner model 116 or from the target font.

The adaptive refiner model 116 is trained in a supervised manner to minimize different losses between the refined glyphs {\hat{ }X2(ctk, st)}Kk=1 and the ground truth {X(ctk, st)}Kk=1. In particular, the adaptive refiner model 116 can be trained using three losses during adaptation: 1) adversarial loss to generate realistic glyphs, 2) perceptual loss to generate glyphs that are perceptually similar to the ground truth, and 3) L1 loss to generate glyphs that match the ground truth at pixel-level.

Adversarial loss: The adaptive refiner model 116 is trained to minimize Wasserstein loss with gradient penalty during adaptation. The refiner R tries to fool the discriminator D by generating glyphs that are close to the target font. Gradient penalty is used to penalize the discriminator if the norm of the gradient update is large which helps the discriminator to converge.

$$Ladv = max D min R E [ log D ( X ( ct , st ) ) + log ( 1 - D ( {}^{⋀} X 2 ( ct , st ) ) ) ] \qquad ( 3 )$$

Perceptual loss: This loss function is used to perform style transfer and enhance the perceptual quality in the generations. For example, the system can utilize the feature reconstruction loss component of perceptual loss during refiner adaptation so that the refined glyphs are perceptually similar to the ground truth. The feature reconstruction loss minimizes the L1 loss between the feature maps of the refined output and the ground truth obtained from different layers of the pretrained VGG16 model. To train the refiner, the system can use relu1_2, relu2_2, relu3_3 and relu4_3 layers of the VGG16 model. The perceptual loss term is:

$$Lperc = P Σ p = 1 L 1 ( layer p {(}^{⋀} X 2 ( ct , st ) ) , layer p ( X ( ct , st ) ) ) \qquad ( 4 )$$

$$where layer refers to different VGG 16 layers .$$

L1 loss: The system can train the adaptive refiner model 116 to minimize pixel wise loss between the refined output and ground truth. Since training generative models using L2 loss results in generation of blurry outputs, the system can minimize L1 loss between xtc, true and xtc,re f. The L1 loss term is:

$$LL 1 = L 1 {(}^{⋀} X 2 ( c t , st ) , X ( ct , st ) ) \qquad ( 5 )$$

Overall loss: The overall loss term for the adaptive refiner model 116 is:

$$Lgen = λ L 1 * LL 1 + λ perc * Lperc + λ adv * Ladv , R \qquad ( 6 )$$

The overall loss term for the discriminator is:

$$Ldisc = λ adv * Ladv , D + λ gp * Lgp \qquad ( 7 )$$

In the above expressions, the coefficients of different loss terms ALI, Aperc, dadv and Agp are hyperparameters.

The AI font generation system 102 can provide the output of the adaptive refiner model 116 to the vectorization 112.

At 218, the AI font generation system 102 can initiate the vectorization process. In some examples, the AI font generation system 102 can vectorize the rasterized images output by the finetuned AI model 110. In some examples, the AI font generation system 102 can vectorize the rasterized images output by the adaptive refiner, in the example where the adaptive refiner was needed to improve the quality of the glyphs, e.g., at 116. The vectorization of the rasterized images includes performing edge detection on the output pixels, path creation of the pixels in the rasterized images to create vector files of the output glyphs, and other functions.

At 220, the AI font generation system 102 can extract spacing from the predicted images. The spacing can include the spacing that was incorporated at 212. For example, the AI font generation system 102 can remove lines from the output raster image, pixels of spaces from the output raster image, and metadata from the output raster image that describes the spacing in the corresponding output raster image.

At 222, in response to extracting the spacing data from the output raster image, the AI font generation system 102 can package the vector outlines into a font. The packaging of vector outlines into a font includes the process of instantiating each character in vector format output from the finetuned AI model. This includes ensuring the font of each character can be scaled according to any size without losing clarity or quality, such as without becoming pixelated when used in a large font size. As a result, the AI font generation system 102 generates a package of characters in vector format, each character presented in a font matching to the particular font of the input characters.

At 224, the AI font generation system 102 can perform a vector refitting process. In some cases, the output of the vectorization in 218 may produce errors. The errors can include, for example, one or more additional points, a misalignment of one or more of the output glyphs, an incorrect rotation of one or more of the output glyphs, a scaling inconsistency across each of the output glyphs, and other inconsistencies noted across the output characters. The AI font generation system 102 can automatically analyze each of the glyphs output in vector form to detect any one of these errors. If the AI font generation system 102 does not detect an error in the output vectors, then the process proceeds to 226. If one or more errors are detected, then the AI font generation system 102 can automatically correct the detected errors.

At 226, the AI font generation system 102 can scale and translate the vectorized glyphs. The vectorized glyphs are scaled and translated to the same format as applied to the input vector glyphs. In this manner, the size and shape of the output vectorized glyphs can match to the size and shape of the vectorized glyphs in 204.

At 228, the AI font generation system 102 outputs the resultant vectorized glyphs to the glyphs application 202. The glyphs application can display the resultant vectorized glyphs showing all the characters in the particular font matching to the particular font from the input glyphs.

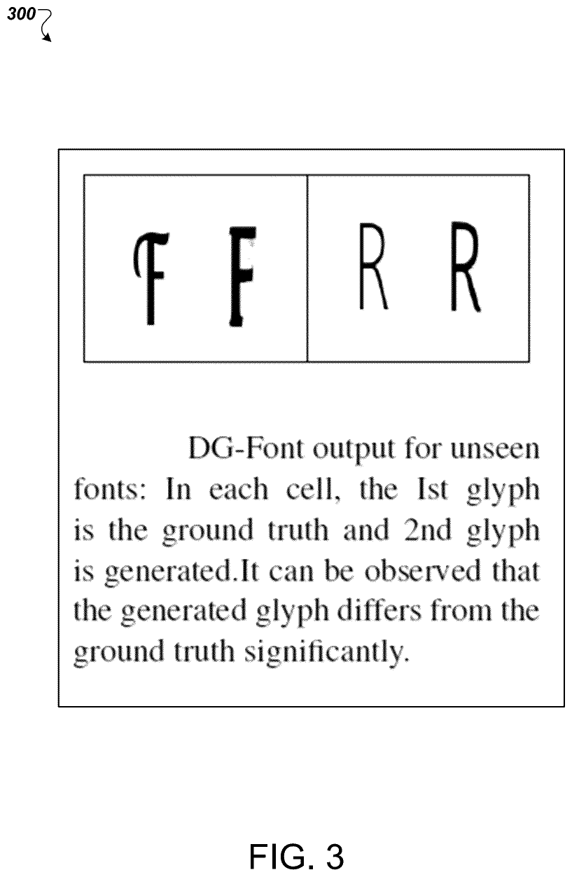

FIG. 3 illustrates ground truth font characters and generated font characters. For example, FIG. 3 illustrated output for unseen fonts. In each cell, the first glyph illustrates the ground truth, and the second glyph is generated. Here, FIG. 3 illustrates that the generated glyph differs from the ground truth significantly.

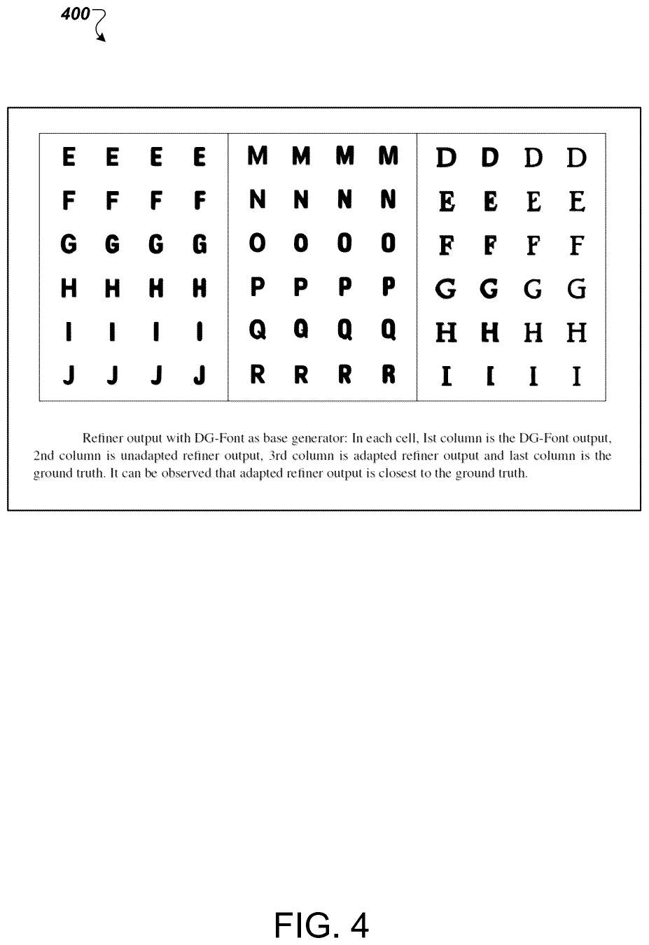

FIG. 4 graphically represents a refiner output of one font as a base generator. In particular, FIG. 4 shows refiner output as a base generator. In each cell, the first column illustrates the base generator output, the second column illustrates unadapted refiner output, and the third column illustrates the adapted refiner output, and the last column shows the ground truth. Thus, it can be observed that adapted refiner output is closest to the ground truth.

FIG. 5 illustrates a creation of a new font from a target font through process 500. The process 500 illustrates different components that work collectively to create glyphs for a new font from a target font for one or more characters. The process 500 may be performed by the AI font generation system 102.

The process 500 illustrates a generative artificial intelligence pipeline that seeks to convert a source image with a base font to a target image using one or more reference images, where both the target image and the one or more reference images illustrate a target font. The target image and the one or more reference images are illustrated in the same font type, and the source image is shown in a different font type. The process 500 attempts to learn the process of converting the source image into the target image using various encoders and a stable diffusion model, e.g., a U-Net. The process 500 can be performed in a training environment and a deployed, e.g., inference, environment. During deployment, the path includes the target image 512, the encoder 516, the latent 518, the noise 520, the noisy latent 522, the scheduler 526, and the loss 530 are not used, since the deployed U-Net is trained.

In some implementations, the process 500 may be executed in response to feedback provided by a user that a particular character does not match a desired font. The AI font generation system 102 can attempt to match the particular character to the desired font in the reference images 204 using the process described below.

As illustrated in FIG. 5, a dataset 502 can include the reference images 504, the source image 510, and the target image 512. The AI font generation system 102 may retrieve the dataset 502 from the glyph database 104. The AI font generation system 102 may provide the reference images 504 to a style encoder 506, the source image 510 to a structure encoder 514, and the target image 512 to an encoder 516. For example, as illustrated in FIG. 5, the reference images 504 includes the words “HamburgeFONT”, the source image 510 includes a letter “K” in an initial font, and the target image 512 includes a letter “K” in a desired font.

The style encoder 506 receives the reference images 504 and converts the reference images 504 into a first embedding. The first embedding is a representation of the reference images 504 in a particular dimensionality. The structure encoder 514 receives the source image 510 and converts the source image 510 into a second embedding. Similar to the first embedding, the second embedding is a representation of the source image 510 in a particular dimensionality. Similarly, the encoder 516 can be a variational autoencoder. The encoder 516 converts the target image 512 into an embedding, but captures fine details of the target image 512 to generate a high dimensional embedding output by the encoder 516.

In some implementations, the style encoder 506 determines the font of the reference images 504. Based on the determined font, the style encoder 506 outputs a representation of the font of the reference images 504 in the form of a first embedding or a style embedding. The first embedding may be, for example, a 128-dimensional value.

In some implementations, the structure encoder 514 can determine the structure of the character in the source image 510. For example, the structure encoder 514 determines the structure of the letter “K” in the source image 510 and outputs a representation of the structure in the form of the second embedding or a structure embedding. The second embedding may be, for example, a 128-dimensional value.

The AI font generation system 102 can combine the style embedding and the structure embedding to generate a context embedding 508. In some cases, the context embedding 508 can include a concatenation of the style embedding and the structure embedding. In some cases, the context embedding 508 include a merged version of the style embedding and the structure embedding. The merged version of the style embedding and the structure embedding may be combined using summation, XOR'ing, or another type of merger. The AI font generation system 102 provides the context embedding to the U-Net 624.

In some cases, if the context embedding 508 is created through concatenation, then no embedding information is lost and the U-Net 524 has more information from the output embedding to process. However, the U-Net 524 will require more time to process the concatenated embedding, which will improve the overall accuracy of the U-Net 524 but, in some cases, can reduce the speed at which the AI font generation system 102 processes.

In some cases, if the context embedding 508 is created through merging, then some embedding information may be lost in the process and the U-Net 524 may have less information to process. However, the U-Net 524 will require less time to train because the size of the merged context embedding 508 is smaller than the concatenated version of the context embedding 508. The accuracy of the U-Net 524 may also be less because since information is lost by aggregating the embeddings, e.g., relative to using the concatenated output embedding.

In some implementations, the encoder 516 processes the target image 512 to ensure the output at the end of the process 500 matches to the font shown in the target image 512. However, during deployment, the path that utilizes the target image 512, the encoder 516, the latent 518, the noise 520, the noisy latent 522, the scheduler 526, and the loss 530 is not used. This path is only used during training.

In some implementations, the generative artificial intelligence model can include a U-Net 524. The U-Net 524 is a latent diffusion model that includes an encoder block to map images to a lower-dimensional latent space before applying the sequence of transformations and a decoder block to map from the lower-dimensional latent space back into image space. For instance, the U-Net 524 includes skip connections that allow the model to combine both coarse features from the beginning of the sequence of transformations and fine features from the end of the sequence of transformations to improve the generated image quality. In some implementations, the U-Net 524 receives and processes the context embedding 508.

During training, the U-Net 524 can receive information output by the encoder 516. The output by the encoder 516 is delayed by a latent 518, a noise 520, and summed and provided to the U-Net 524.

In some implementations, the U-Net 524 can output an encoded representation of the output as an image. The encoded representation of the output as the image can be provided through a latent 538 and to a decoder 532. The latent 538 can create an encoding of the image output by the U-Net 524. The decoder 532 can decode the letter output by the U-Net 524, and provide the letter as output 534. Accordingly, the output 534 showing the letter “K” can match to the font shown in the reference images 504 and the font shown in the target image 512. During training, the U-Net 524 may provide loss data 530 to the noise 520 and receive a time embedding through the scheduler 526. The time embedding may be helpful in training the U-Net 524 using input embeddings.

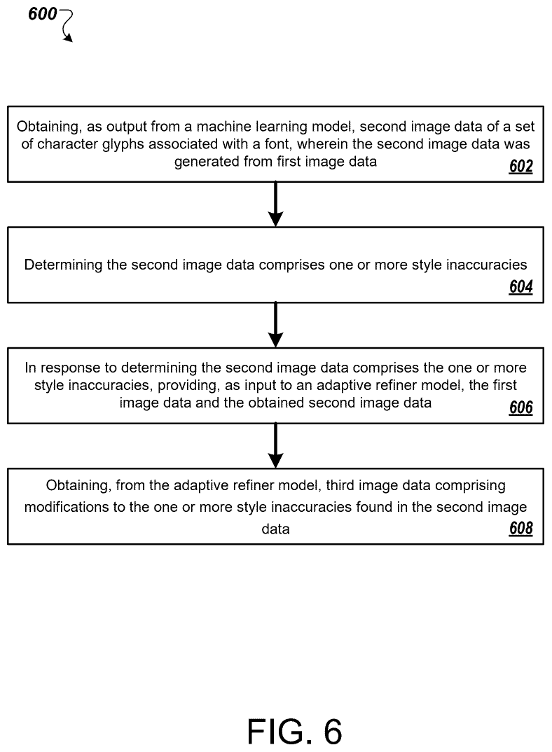

FIG. 6 is a flow diagram that illustrates an example of a process 600 for utilizing an adaptive refiner to produce a refined image of a glyph. For example, the AI font generation system 102 of FIG. 1 can perform the process 600.

The AI font generation system can obtain, as output from a machine learning model, second image data of a set of character glyphs associated with a font, wherein the second image data was generated from first image data (602). The AI font generation system can receive data representing a character glyph associated with the font and generate first image data from the character glyph. Then, the AI font generation system can provide as input to the machine learning model the generated first image data. Here, the machine learning model can include a stable diffusion model.

The AI font generation system can determine the second image data includes one or more style inaccuracies (604). For example, the AI font generation system can determine the second image data include one or more style inaccuracies relating to at least one of a slant, a thickness, a length, and local style features of the font in one or more glyphs. If the AI font generation system determines one or more of these characteristics exceed a threshold value, e.g., a slant angle exceeds a threshold value, a thickness value of a glyph exceeds a threshold value, and a length value of a glyph exceeds a threshold value, then the AI font generation system can flag that one or more style inaccuracies have been found. For example, the AI font generation system can use one or more algorithms to analyze the characteristics of the glyphs, e.g., analyzing the slant, thickness, and length, of different portions of the glyph, to make the determination as to whether one or more style inaccuracies exist.

In response to determining the second image data includes the one or more style inaccuracies, the AI font generation system can provide, as input to an adaptive refiner model, the first image data and the obtained second image data (606). Here, the AI font generation system can generate input data that includes a concatenation of the generated first image data and the obtained second image data. The AI font generation system can provide the concatenated generated first image data and the obtained second image data as input to the adaptive refiner model.

The AI font generation system can obtain, from the adaptive refiner model, third image data that includes modifications to the one or more style inaccuracies found in the second image data (608). Here, the first image data, the second image data, and the third image data includes rasterized images. The third image data can include corrections, modifications, or improvements to the characteristics of the glyphs that included the one or more style inaccuracies.

In response to generating the third image data, the AI font generation system can generate a vector format of the obtained third image data of the set of character glyphs and can scale the generated vector format to match to a form of the data representing the character glyph. The AI font generation system can provide the scaled vector of the set of character glyphs for output, e.g., for display on a user device, wherein the scaled vector includes a set of character glyphs associated with the font.

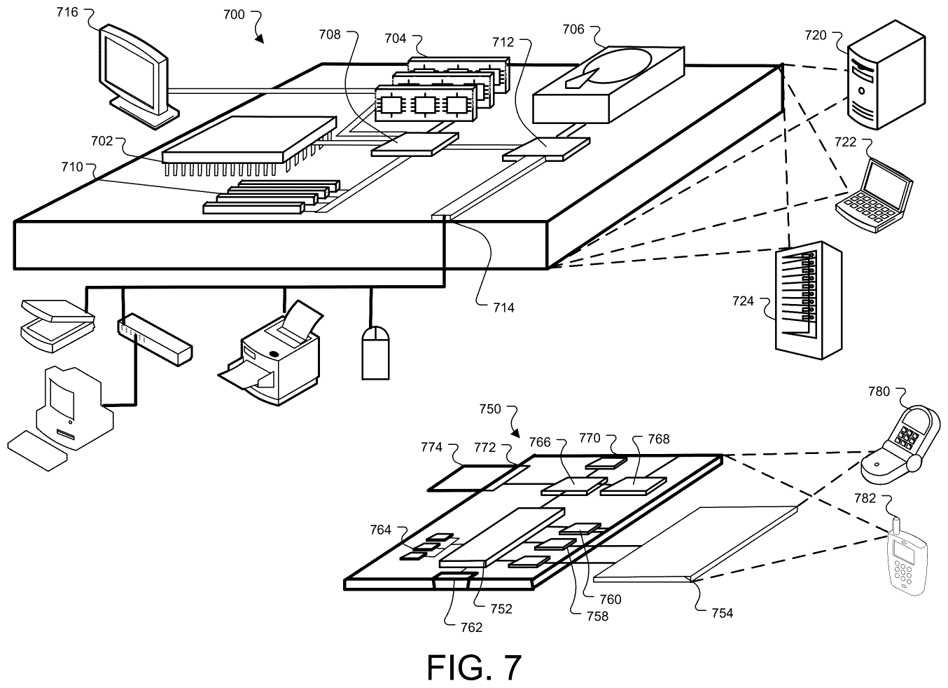

FIG. 7 shows an example of example computer device 700 and example mobile computer device 750, which can be used to implement the techniques described herein. For example, a portion or all of the operations for generating font glyphs using an adaptive refiner, etc. may be executed by the computer device 700 and/or the mobile computer device 750. Computing device 700 is intended to represent various forms of digital computers, including, e.g., laptops, desktops, workstations, personal digital assistants, servers, blade servers, mainframes, and other appropriate computers. Computing device 750 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 700 includes processor 702, memory 704, storage device 706, high-speed interface 708 connecting to memory 704 and high-speed expansion ports 710, and low-speed interface 712 connecting to low-speed bus 714 and storage device 706. Each of components 702, 704, 706, 708, 710, and 712, are interconnected using various busses, and can be mounted on a common motherboard or in other manners as appropriate. Processor 702 can process instructions for execution within computing device 700, including instructions stored in memory 704 or on storage device 706 to display graphical data for a GUI on an external input/output device, including, e.g., display 716 coupled to high-speed interface 708. In other implementations, multiple processors and/or multiple busses can be used, as appropriate, along with multiple memories and types of memory. Also, multiple computing devices 700 can be connected, with each device providing portions of the necessary operations (e.g., as a server bank, a group of blade servers, or a multi-processor system).

Memory 704 stores data within computing device 700. In one implementation, memory 704 is a volatile memory unit or units. In another implementation, memory 704 is a non-volatile memory unit or units. Memory 704 also can be another form of computer-readable medium (e.g., a magnetic or optical disk. Memory 704 may be non-transitory.)

Storage device 706 is capable of providing mass storage for computing device 700. In one implementation, storage device 706 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer-or machine-readable medium, (e.g., memory 704, storage device 706, memory on processor 702, and the like.)

High-speed controller 708 manages bandwidth-intensive operations for computing device 700, while low-speed controller 712 manages lower bandwidth-intensive operations. Such allocation of functions is an example only. In one implementation, high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 700 can be implemented in a number of different forms, as shown in the figure. For example, it can be implemented as standard server 720, or multiple times in a group of such servers. It also can be implemented as part of rack server system 724. In addition or as an alternative, it can be implemented in a personal computer (e.g., laptop computer 722.) In some examples, components from computing device 700 can be combined with other components in a mobile device (not shown), e.g., device 750. Each of such devices can contain one or more of computing device 700, 750, and an entire system can be made up of multiple computing devices 700, 750 communicating with each other.

Computing device 750 includes processor 752, memory 764, an input/output device (e.g., display 754, communication interface 766, and transceiver 768) among other components. Device 750 also can be provided with a storage device, (e.g., a microdrive or other device) to provide additional storage. Each of components 750, 752, 764, 754, 766, and 768, are interconnected using various buses, and several of the components can be mounted on a common motherboard or in other manners as appropriate.

Processor 752 can execute instructions within computing device 750, including instructions stored in memory 764. The processor can be implemented as a chipset of chips that include separate and multiple analog and digital processors. The processor can provide, for example, for coordination of the other components of device 750, e.g., control of user interfaces, applications run by device 750, and wireless communication by device 750.

Processor 752 can communicate with a user through control interface 758 and display interface 756 coupled to display 754. Display 754 can be, for example, a TFT LCD (Thin-Film-Transistor Liquid Crystal Display) or an OLED (Organic Light Emitting Diode) display, or other appropriate display technology. Display interface 756 can comprise appropriate circuitry for driving display 754 to present graphical and other data to a user. Control interface 758 can receive commands from a user and convert them for submission to processor 752. In addition, external interface 762 can communicate with processor 742, so as to enable near area communication of device 750 with other devices. External interface 762 can provide, for example, for wired communication in some implementations, or for wireless communication in other implementations, and multiple interfaces also can be used.

Memory 764 stores data within computing device 750. Memory 764 can be implemented as one or more of a computer-readable medium or media, a volatile memory unit or units, or a non-volatile memory unit or units. Expansion memory 774 also can be provided and connected to device 750 through expansion interface 772, which can include, for example, a SIMM (Single In Line Memory Module) card interface. Such expansion memory 774 can provide extra storage space for device 750, or also can store applications or other data for device 750. Specifically, expansion memory 774 can include instructions to carry out or supplement the processes described above, and can include secure data also. Thus, for example, expansion memory 774 can be provided as a security module for device 750, and can be programmed with instructions that permit secure use of device 750. In addition, secure applications can be provided through the SIMM cards, along with additional data, (e.g., placing identifying data on the SIMM card in a non-hackable manner.)

The memory 764 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 764, expansion memory 774, and/or memory on processor 752), which can be received, for example, over transceiver 768 or external interface 762.

Device 750 can communicate wirelessly through communication interface 766, which can include digital signal processing circuitry where necessary. Communication interface 766 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 768. In addition, short-range communication can occur, e.g., using a Bluetooth®, WiFi, or other such transceiver (not shown). In addition, GPS (Global Positioning System) receiver module 770 can provide additional navigation-and location-related wireless data to device 750, which can be used as appropriate by applications running on device 750. Sensors and modules such as cameras, microphones, compasses, accelerators (for orientation sensing), etc. may be included in the device.

Device 750 also can communicate audibly using audio codec 760, which can receive spoken data from a user and convert it to usable digital data. Audio codec 760 can likewise generate audible sound for a user, (e.g., through a speaker in a handset of device 750.) Such sound can include sound from voice telephone calls, can include recorded sound (e.g., voice messages, music files, and the like) and also can include sound generated by applications operating on device 750.

Computing device 750 can be implemented in a number of different forms, as shown in the figure. For example, it can be implemented as cellular telephone 780. It also can be implemented as part of smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. (canceled)

2. (canceled)

3. (canceled)

4. A method comprising:
obtaining, as output from a machine learning model, second image data of a set of character glyphs associated with a font, wherein the second image data was generated from first image data;
determining the second image data comprises one or more style inaccuracies;
in response to determining the second image data comprises the one or more style inaccuracies, providing, as input to an adaptive refiner model, the first image data and the obtained second image data; and
obtaining, from the adaptive refiner model, third image data comprising modifications to the one or more style inaccuracies found in the second image data.

5. The method of claim 4, further comprising:
obtaining, as output from the machine learning model, the second image data of the set of character glyphs with the font includes: receiving data representing a character glyph associated with the font;
generating first image data from the character glyph; and
providing, as input to the machine learning model, the generated first image data.

6. The method of claim 4, wherein providing, as input to the machine learning model, the generated first image data comprises providing, as input to a stable diffusion model, the generated first image data.

7. The method of claim 4, wherein determining the second image data comprises the one or more style inaccuracies comprises determining one or more inaccuracies comprising a slant, a thickness, a length, and local style features of the font.

8. The method of claim 4, wherein providing, as input to the adaptive refiner model, the generated first image data and the obtained second image data comprises:
generating input data that includes a concatenation of the generated first image data and the obtained second image data; and
providing, as input to the adaptive refiner model, the generated input data that comprises the concatenation.

9. The method of claim 4, wherein the first image data, the second image data, and the third image data comprise rasterized images.

10. The method of claim 4, further comprising:
generating a vector format of the obtained third image data of the set of character glyphs;
scaling the generated vector format to match to a form of the data representing the character glyph; and
providing the scaled vector of the set of character glyphs for output, wherein the scaled vector comprises a set of character glyphs associated with the font.

11. A system comprising:
one or more computers and one or more storage devices storing instructions that are operable, when executed by the one or more computers, to cause the one or more computers to perform operations comprising:
obtaining, as output from a machine learning model, second image data of a set of character glyphs associated with a font, wherein the second image data was generated from first image data;
determining the second image data comprises one or more style inaccuracies;
in response to determining the second image data comprises the one or more style inaccuracies, providing, as input to an adaptive refiner model, the first image data and the obtained second image data; and
obtaining, from the adaptive refiner model, third image data comprising modifications to the one or more style inaccuracies found in the second image data.

12. The system of claim 11, further comprising:
obtaining, as output from the machine learning model, the second image data of the set of character glyphs with the font includes: receiving data representing a character glyph associated with the font;
generating first image data from the character glyph; and
providing, as input to the machine learning model, the generated first image data.

13. The system of claim 11, wherein providing, as input to the machine learning model, the generated first image data comprises providing, as input to a stable diffusion model, the generated first image data.

14. The system of claim 11, wherein determining the second image data comprises the one or more style inaccuracies comprises determining one or more inaccuracies comprising a slant, a thickness, a length, and local style features of the font.

15. The system of claim 11, wherein providing, as input to the adaptive refiner model, the generated first image data and the obtained second image data comprises:
generating input data that includes a concatenation of the generated first image data and the obtained second image data; and
providing, as input to the adaptive refiner model, the generated input data that comprises the concatenation.

16. The system of claim 11, wherein the first image data, the second image data, and the third image data comprise rasterized images.

17. The system of claim 11, further comprising:
generating a vector format of the obtained third image data of the set of character glyphs;
scaling the generated vector format to match to a form of the data representing the character glyph; and
providing the scaled vector of the set of character glyphs for output, wherein the scaled vector comprises a set of character glyphs associated with the font.

18. A non-transitory computer-readable medium storing software comprising instructions executable by one or more computers which, upon such execution, cause the one or more computers to perform operations comprising:
obtaining, as output from a machine learning model, second image data of a set of character glyphs associated with a font, wherein the second image data was generated from first image data;
determining the second image data comprises one or more style inaccuracies;
in response to determining the second image data comprises the one or more style inaccuracies, providing, as input to an adaptive refiner model, the first image data and the obtained second image data; and
obtaining, from the adaptive refiner model, third image data comprising modifications to the one or more style inaccuracies found in the second image data.

19. The non-transitory computer-readable medium of claim 18, further comprising:
obtaining, as output from the machine learning model, the second image data of the set of character glyphs with the font includes: receiving data representing a character glyph associated with the font;
generating first image data from the character glyph; and
providing, as input to the machine learning model, the generated first image data.

20. The non-transitory computer-readable medium of claim 18, wherein providing, as input to the machine learning model, the generated first image data comprises providing, as input to a stable diffusion model, the generated first image data.

21. The non-transitory computer-readable medium of claim 18, wherein determining the second image data comprises the one or more style inaccuracies comprises determining one or more inaccuracies comprising a slant, a thickness, a length, and local style features of the font.

22. The non-transitory computer-readable medium of claim 18, wherein providing, as input to the adaptive refiner model, the generated first image data and the obtained second image data comprises:
generating input data that includes a concatenation of the generated first image data and the obtained second image data; and
providing, as input to the adaptive refiner model, the generated input data that comprises the concatenation.

23. The non-transitory computer-readable medium of claim 18, wherein the first image data, the second image data, and the third image data comprise rasterized images.
